(19) United States
(12) Patent Application Publication
(10) Pub. No.: US 2017/0180189 A1
(43) Pub. Date: Jun. 22, 2017

(54) FUNCTIONAL STATUS EXCHANGE BETWEEN NETWORK NODES, FAILURE DETECTION AND SYSTEM FUNCTIONALITY RECOVERY

(71) Applicant: NOKIA SOLUTIONS AND NETWORKS OY, Espoo (FI)

(72) Inventors: Santhosh Kumar HOSDURG, Dunwoody, GA (US); Krishnan IYER, Dunwoody, GA (US); Devaki CHANDRAMOULI, Plano, TX (US)

(21) Appl. No.: 15/316,335

(22) PCT Filed: Jun. 3, 2014
(86) PCT No.: PCT/US14/40733

§ 371 Date: Dec. 5, 2016

(51) Int. Cl. H04L 12/24; H04L 29/08; G06F 11/20

(52) U.S. Cl. CPC H04L 41/0654; G06F 11/203; H04L 69/329; H04L 41/12; G06F 2201/805

(57) ABSTRACT

Determination of status of network nodes may be useful in various communication systems. For example, functional status exchange between network nodes, failure detection, and system functionality recovery may be applied in mobile and/or data communication networks. A method can include detecting, by a device, status of an application layer of a node. The method can also include informing, in a message, at least one other node of the status of the application layer of the node.

### BACKGROUND

Field

Determination of status of network nodes may be useful in various communication systems. For example, functional status exchange between network nodes, failure detection, and system functionality recovery may be applied in mobile and/or data communication networks.

Description of the Related Art

system architecture can include multiple functional network elements. Each functional network element/node can communicate frequently with multiple network elements with predefined protocols. Despite protocol level information sharing between peer nodes, there is hardly any mechanism in place for a peer node to tell a neighboring peer node about its own functional status as well as all functional statuses of other peer nodes to which a given node has a relationship.

A node's inability to relay information to a peer node about the node's own functional status and errors, as well as functional status and errors of other adjacent nodes with which the node has a relation, causes a hindrance in recovery of the system.

In enhanced universal terrestrial radio access network (eUTRAN)/evolved packet core (EPC) system architecture, there are no mechanisms to indicate application layer unavailability, such as that application layer is non-responsive, between peering entities. Even when the streaming control transmission protocol (SCTP) link and association between two SCTP end points such as a mobility management entity (MME) and evolved Node B (eNB) is up and running, the MME or eNB application itself may be in a frozen state. For example, the application may not respond to application layer messages and/or send error messages to lower layers, such as the SCTP layer.

There are no features to ensure the availability of interface S1 application protocol (S1AP) layer between eNB and MME. If the MME application layer, using S1AP, is not responding to network access stratum (NAS) requests sent by the user equipment (UE), the UEs may not get the service from the network. This may result in degradation of network key performance indicators (KPIs) and an outage to UE. Due to lack of response, UE may re-attempt NAS request multiple times before it gives up and tries other means (i.e. RAT selection or PLMN selection) to obtain service. This process takes significant amount of time and impacts user experience.

3GPP technical specification (TS) 24.301 Rel10, which is hereby incorporated herein by reference in its entirety specifies that the UE can re-attempt NAS requests at least 5 times prior to taking other measures for service recovery i.e. RAT selection, PLMN selection. The eNB-MME connectivity failure as such will be generated only when the SCTP association failure occurs in the network due to transport issues or if the S1AP layer in the MME itself is down. There are no specific error-handling mechanisms to isolate situations when the S1AP layer has had a fatal error and is not responding to NAS message request sent by UE's. The failed MME is not removed from the pool of MME(s) available for eNB to select.

Currently, there are no mechanisms to exchange application statuses of all protocols being run on a peer node to an adjacent node. For example, the MME doesn't provide its S6a or S11 interface status to eNB. In case of MME to HSS link failure, the s6a interface may be down. When the UEs try to attach to the LTE network, the attach may fail. The UE can continue to attach to the network. If the fault remains, the UE may end up getting no service. Subject to availability of other networks within the same operator and the UE's subscription to those networks, some UEs may be able to get service in another domain, universal mobile telecommunication system (UMTS) or global system for mobile communication (GSM).

Although implementation and behavior of UEs may vary, if a UE gets an attach reject from an LTE network because the MME to home subscriber server (HSS) link is down, the UE may try five times every fifteen seconds. All of these attempts may go to the same MME as the UE is retrying with a globally unique temporary identifier (GUTI). The UE may then start the T3402 timer and reselect GSM enhanced data for global evolution (EDGE) radio access network (GERAN)/UTRAN when available/supported. Some UEs may attach in LTE seemingly indefinitely if there is no fallback RAT available for registration. This will cause a service outage for those UEs.

In current implementations, the control plane application relies on the SCTP layer to inform the peer node to update the application layer faults. This method relies on application layer informing the SCTP layer about the application state availability/error status.

During a critical failure or frozen state scenario at the application layer within a node, for example on the server side, the application layer may be unable to communicate to the SCTP layer. Thus, the peer node, for example client side, may consider the other node, for example server side, application layer to be in service, which may result in loss of failure detection and recovery. This may trigger a network outage or service impact to end users.

### SUMMARY

According to certain embodiments, a method can include detecting, by a device, status of an application layer of a node. The method can also include informing, in a message, at least one other node of the status of the application layer of the node.

In certain embodiments, a method can include determining status of an application layer of a node at an other node. The method also includes initiating at least one recovery action based on determination of the status at the other node.

A non-transitory computer readable medium can, in certain embodiments, be encoded with instructions that, when executed in hardware, perform a process. The process can include the method according to any of the previous methods.

A computer program product can, according to certain embodiments, encode instructions for performing a process. The process can include the method according to any of the previous methods.

According to certain embodiments, an apparatus can include at least one processor and at least one memory including computer program code. The at least one memory and the computer program code can be configured to, with the at least one processor, cause the apparatus at least to detect, by a device, status of an application layer of a node. The at least one memory and the computer program code can also be configured to, with the at least one processor, cause the apparatus at least to inform, in a message, at least one other node of the status of the application layer of the node.

In certain embodiments, an apparatus can include at least one processor and at least one memory including computer program code. The at least one memory and the computer program code can be configured to, with the at least one processor, cause the apparatus at least to determine status of an application layer of a node at an other node. The at least one memory and the computer program code can also be configured to, with the at least one processor, cause the apparatus at least to initiate at least one recovery action based on determination of the status at the other node.

An apparatus, according to certain embodiments, can include means for detecting, by a device, status of an application layer of a node. The apparatus can also include means for informing, in a message, at least one other node of the status of the application layer of the node.

An apparatus, in certain embodiments, can include means for determining status of an application layer of a node at an other node. The apparatus can also include means for initiating at least one recovery action based on determination of the status at the other node.

### BRIEF DESCRIPTION OF THE DRAWINGS

For proper understanding of the invention, reference should be made to the accompanying drawings, wherein:

FIG. 1 illustrates application status information over SCTP according to certain embodiments.

FIG. 2 illustrates application status over SCTP including a remote node failure indication, according to certain embodiments.

FIG. 3 illustrates normal operation according to certain embodiments.

FIG. 4 illustrates a scenario in which application layer failure has occurred in one node, according to certain embodiments.

FIG. 5 illustrates a typical node processor architecture.

FIG. 6 illustrates typical fatal error locations and use of an SCTP layer abort procedure, according to certain embodiments.

FIG. 7 illustrates a critical failure scenario, according to certain embodiments.

FIG. 8 illustrates an eNB healing mechanism according to certain embodiments.

FIG. 9 illustrates a method according to certain embodiments.

FIG. 10 illustrates another method according to certain embodiments.

FIG. 11 illustrates a system according to certain embodiments of the invention.

### DETAILED DESCRIPTION

Certain embodiments provide a mechanism for peer nodes engaged in communication with one another to inform one another about the availability of an application layer on the node. Thus, among other benefits or advantages, recovery actions may be initiated before major service interruption occurs for the end-users relying on application to provide them with network service.

More generally, certain embodiments provide a mechanism to inform peer nodes engaged in communication about the availability of application layer, including functional status and errors on an own node as well as other peer nodes to which the node has an active relation, including status/relation that the node has received from other peer nodes.

Most networks today rely on a robust transport network protocol such as SCTP to maintain integrity of a link between peer nodes for communication. Certain embodiments use a “Vendor specific IE field” in any of the SCTP message(s). The information element could be just another information element in an SCTP heartbeat message or in a data chunk or selective acknowledgment (SACK), to include application type/protocol/error code status.

The vendor-specific information element (IE), “Application Status,” can include application status at protocol granularity and error. Certain embodiments can further classify application status of own element as well as peer element, other than the peer element to which this information is relayed. The peer element may be any element with which the device has a relationship.

Thus, the parameter according to certain embodiments can be a vendor-specific IE in an SCTP message. The parameter can be called “Application Status,” and can have the following sub parameters and state information, each of which is provided only by way of non-limiting example: Protocol S1-MME-Status-OK/NOK; Protocol S1-eNB-Status-OK/NOK; Protocol S6a-MME Status-OK/NOK; and/or Protocol S6a-HSS Status-OK/NOK. Protocol S6a-HSS status may also be optionally appended with the PLMN ID information as a certain MME may be connected to HSS in multiple PLMNs. By default, Protocol S6a-HSS Status-OK/NOK indicates the status of connectivity between MME and HSS in the same PLMN.

The amount of parameters or sub-parameters to be populated may depend on the perceived usefulness of the information at any given remote node in order to consider appropriate action in response to such information.

A relevant node can analyze the application status message and, upon detection of issues, may trigger recovery actions before major system level service interruption occurs for the end-users or own/peer node services.

As mentioned above, SCTP is the most commonly used control plane protocol to maintain integrity of a link between peer nodes. Although certain embodiments can be used with other control plane protocols or other protocols, certain embodiments provide a unique mechanism that can be used in conjunction with SCTP stack to ensure application layer availability across peer nodes as well.

The eNB to MME interface and MME to HSS interfaces are being used as examples to illustrate certain embodiments, although certain embodiments are applicable to other nodes and interfaces (e.g. MME to MSC/VLR—SGs interface). Currently eNB to MME interface relies on the SCTP layer to communicate any application layer failure. If the application is not responding due to unknown reasons, the SCTP layer would not be able to interpret the failure scenario.

In the context of an S1 interface, the node MME, which can be an S1 application server, may send periodic application status message with IE: S1AP OK message to a peer node, such as eNB, to indicate the MME S1AP application layer is functional with full integrity. The eNB checks its own S1AP Layer and responds to MME with an eNB Application Status Message with IE: S1AP OK indicating that the peer end eNB S1AP layer is functional.

In the context of an S6a interface, the node MME can send periodic application status messages with IE: S6a OK Message to peer node HSS to indicate the MME S6a application layer is functional with full integrity. The HSS can check the HSS's own S6a layer and can respond to the MME with an S6a application status message with IE: S6a OK, indicating that the peer S6a layer is functional.

MME will relay S6a Application Status as well as S1AP application status to eNB. When MME detects S6a failure from all HSS's to which it has active connection (example transport failure towards service core network) MME will send s6a NOK message along with S1AP OK message to the eNB. The eNB upon receiving S6a NOK message will initiate actions to route initial attach requests to different MME in the S1-Flex pool than the one that has indicated the S6a failure. In this case, eNB can also decide to remove the failed MME from the selection pool. If there is no MME pooling deployed, then eNB can also decide to reject the radio resource control (RRC) connection request.

The vendor-specific IE for the SCTP message can also be optionally supported and exchanged with peer nodes by application/served protocols in a network element itself in their respective interfaces/protocols towards peer nodes. Certain embodiments can use a vendor-specific IE in S1AP messages between eNB and MME, a vendor-specific IE in S6a messages between MME and HSS, and so, as applicable to all network element interfaces/protocol layer. Individual nodes can have ability to comprehend the particular application status information received and relay further to peer nodes.

The eNB/EPC nodes and interfaces are used as examples to explain certain embodiments in the following discussion, but these are non-limiting examples and certain embodiments may be applicable to other nodes, interfaces, configurations, and architectures. In the context of an S1 interface, certain embodiments provide the following for normal operation. The MME node or other S1 application server can send a periodic application status message with IE S1AP OK on the SCTP layer to a peer node, such as an eNB, to indicate the MME S1AP application layer is functional with full integrity. The periodicity of the application status message with IE S1AP OK can be defined as N*T, where T corresponds to an SCTP heartbeat message time period and N is a configurable integer greater than 1.

The eNB can check the eNB's own S1AP Layer and can respond to the MME with an eNB: application status message with IE S1AP OK as ACK indicating that the peer end eNB S1AP layer is functional. If MME or eNB S1AP application layer fails to indicate to SCTP layer that it is okay, then the nodes would not send Application Status Message with IE MME: S1AP OK Message or eNB: S1AP OK ACK message.

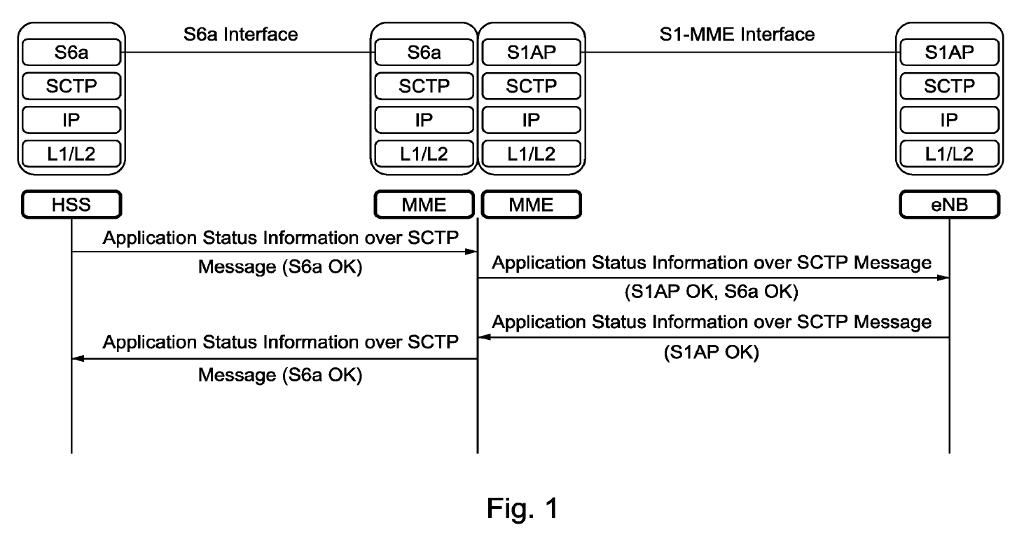

FIG. 1 illustrates application status information over SCTP according to certain embodiments. FIG. 1 shows application status information exchange between network elements. As shown in FIG. 1, an HSS node can send an S6a OK message to all the MME(s) it is connected to, over an SCTP link. The message can state that the HSS's S6a stack is up and running. The MME can not only send an S1AP OK message towards eNB but also relay that the MME's S6a functionality is also OK. In addition, this can include the PLMN ID for the HSS. Similarly, the MME can also relay the status of the MME's S11 functionality towards peer SGWs, which are not shown in the picture.

The MME can just relay back S6a ok message to the HSS, which is considered as an acknowledgement to the S6a OK message sent by the HSS. Similarly, the eNB can just relay back with an S1AP OK message to the MME.

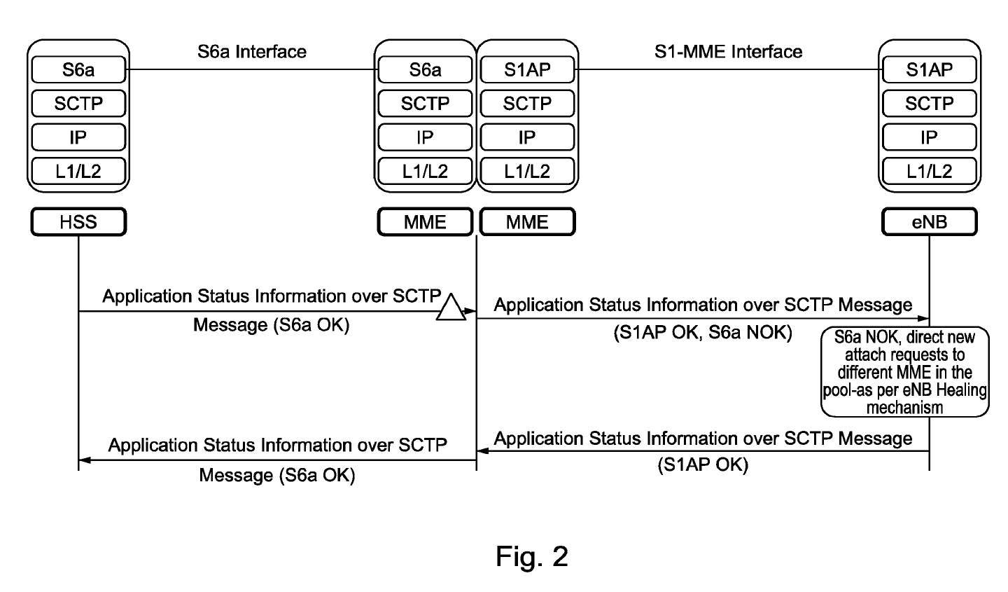

FIG. 2 illustrates application status over SCTP including a remote node failure indication, according to certain embodiments. FIG. 2 shows a scenario where an MME can detect a failure in the MME's transport link toward the HSS. The MME can interpret this as being S6a Not OK. MME can relay this information “56a NOK” to an eNB along with an S1AP OK message. Upon observing that the MME has lost its HSS connectivity, from the “56a NOK” message, the eNB can initiate a healing mechanism to further direct new attach requests to other candidate MMEs, for which it has received an S6a OK and for UE(s) that belong to the PLMN where HSS is located, in the S1-Flex pool. If there is no MME pooling deployed, then eNB can also decide to reject the RRC connection request.

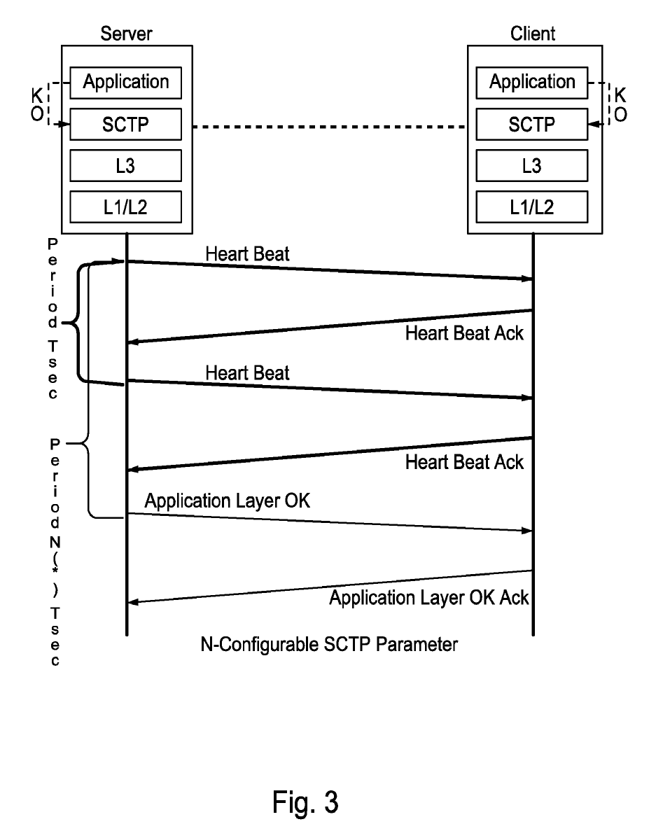

FIG. 3 illustrates normal operation according to certain embodiments. Thus, FIG. 3 shows normal operation in which application layers between peer nodes are OK. Thus, at a periodicity of less than a transport layer heartbeat, an application layer OK message can be sent from server to client, and the client can respond with its own acknowledgment.

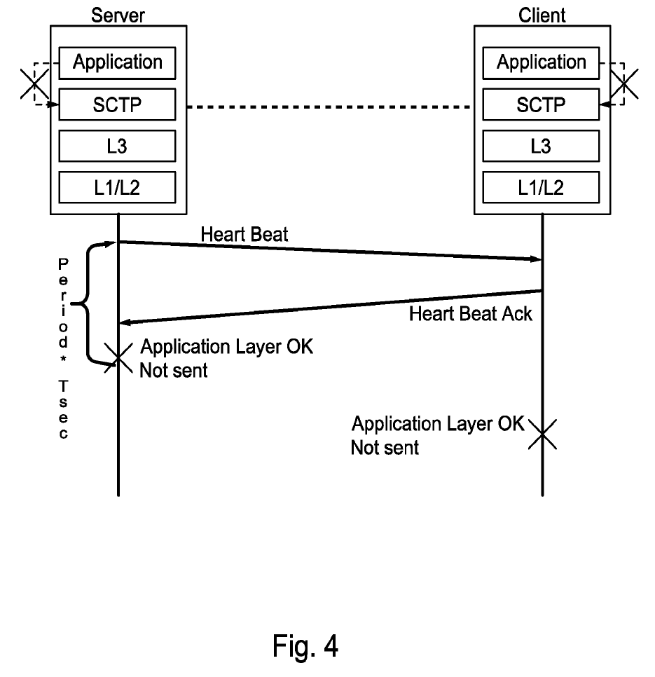

FIG. 4 illustrates a scenario in which application layer failure has occurred in one node, according to certain embodiments. Thus, as shown FIG. 4, when the application layer in a client or server is not working, even though lower layers are working, transport layer heartbeats may be sent, but application layer OK messages may not be sent.

In the context of the S1 interface, certain embodiments provide various ways of handling and detecting fatal error scenarios. A fatal error can correspond to any abnormal failures not limited to software, hardware, or the like pertaining to a node, that can result in network outage or service impact to Users.

These fatal errors can be mapped to specific cause codes, which can be relayed to peer nodes for indicating application layer issues. The error cause value can allow a peer node to take appropriate healing action as discussed below. This mechanism can use existing SCTP abort procedures to indicate local application layer failure causes to peer nodes.

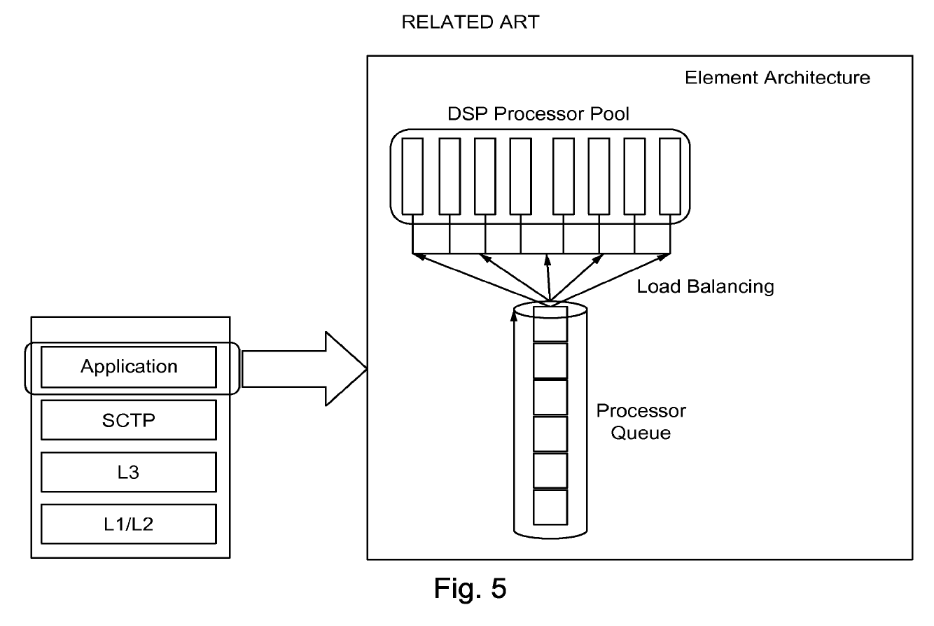

FIG. 5 illustrates a typical node processor architecture. As shown in FIG. 5, a typical node processor architecture can include a processor queue, a load balancer and a digital signal processing (DSP) processor pool.

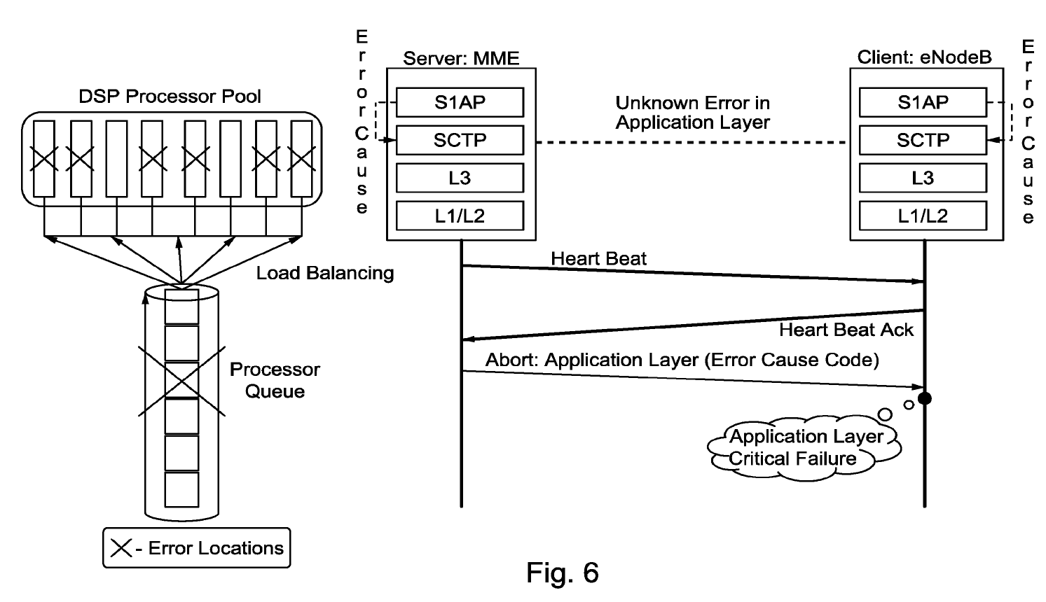

FIG. 6 illustrates typical fatal error locations and use of an SCTP layer abort procedure, according to certain embodiments. More particularly, FIG. 6 illustrates typical fatal error locations within the element architecture, as shown with the Xs. Moreover, FIG. 6 illustrates how certain embodiments can use the SCTP layer abort procedure to report various fatal error causes towards the peer node. For example, when a peer node receives an abort procedure it can flag an alarm. In the example below eNB generates an operational support system (OSS) alarm indicating that MME application layer is not functioning

FIG. 6 uses MME and eNB as example peering entities for illustration purposes. Critical processes responsible for an S1AP stack can be monitored within the MME node. If all critical process/processes that are necessary for providing services are up and running, then the system can be considered operational without any fatal error. Subject to design of the system, the MME may generate fatal error based on predefined attributes. The same fatal error detection mechanism can be applied to various network elements, such as an eNB or the like.

In the context of an S1 interface, certain embodiments can handle and detect application layer critical failure or frozen state, as described below. Application layer critical failure can refer to when a node stops responding to messages and fails to send any indication to an SCTP Layer. Such a situation can be deemed a critical failure. Such situations can result in network outage or service impact to users.

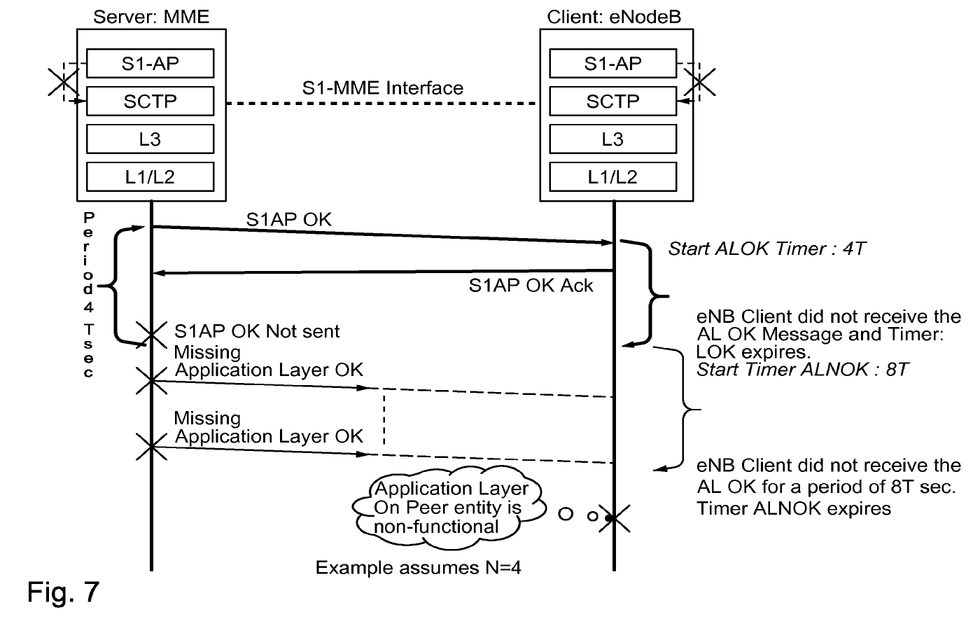

FIG. 7 illustrates a critical failure scenario, according to certain embodiments. More specifically, FIG. 6 illustrates application layer critical failure detection at a peer node.

In normal operation, a MME node, or S1 Application Server, may send periodic S1AP OK Message to a peer node, such as eNB, to indicate that the MME S1AP application layer is functional with full integrity.

The periodicity of S1AP OK messages can be defined as N*T, where T is an SCTP heartbeat message time period and N is a configurable integer greater than 1. As illustrated in FIG. 5, mentioned above, the MME is illustrated as configured to send an SLAP OK message every 4*T seconds using SCTP Layer, and thus N=4 in this non-limiting example. The N*T value can be set to value greater than the time required for the SCTP to detect association failure. In normal operation, the eNB can check its own S1AP layer and can respond to the MME with an eNB: S1AP OK ACK indicating that the peer end eNB S1AP layer is functional.

In case of a critical failure at an S1AP Layer, the following can happen, as depicted in FIG. 7. The MME S1AP application layer may fail to indicate to its SCTP layer that the application layer is “functional with full integrity,” due to application layer critical failure. Thus, the MME may not send an S1AP OK message using the SCTP Layer, which is shown as S1AP OK not sent in FIG. 7.

As shown in FIG. 7, the eNB can await the S1AP OK message from MME before expiry of “ALOK timer=4T.” The eNB may not receive an S1AP OK message from the MME and the ALOK timer can expire.

The eNB can now start “ALNOK timer=8T.” If an MME S1AP OK message is received before the expiry of this timer, then the eNB can stop the ALNOK timer and can start the ALOK timer. The eNB may now assume that the application layer on the MME side is functioning normally.

If the ALNOK timer expires in the eNB before an S1AP OK message is received, then the eNB can assume critical failure of the MME application layer and can start healing procedures as described below. Additionally, the eNB can generate an OSS alarm indicating that the MME application layer is not functioning.

The “ALOK timer” and “ALNOK timer” can be user-configurable timers. The SCTP heartbeat timers can run at a much lower timer value than ALOK or ALNOK timers. If heartbeat failures are detected, namely THearbeat timer expiry occurs, either within an application layer timer window or outside of it, then SCTP failure actions can take precedence. All application layer enabled SCTP messaging procedures can be suspended until SCTP recovery.

In the context of the S1 Interface, certain embodiments can provide a healing mechanism in case of application level critical failures and abort procedures. As described above, the eNB can detect either an application layer fatal error or an application layer critical failure and can trigger a healing mechanism.

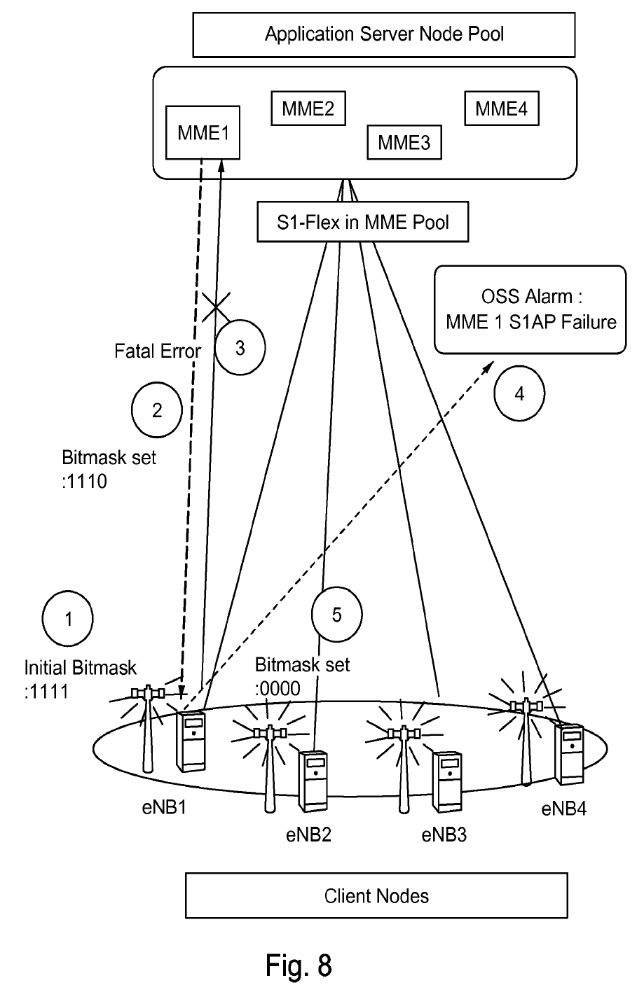

FIG. 8 illustrates an eNB healing mechanism according to certain embodiments. An eNB can detect a problem with a peer node, such as an MME, application layer—in this example S1-AP—based on a scenario in which there is an abort with a fatal error or there is an ALNOK timer expiry. Each eNB can maintain a bit mask, for example 16 bits, for each server, for example MME, that the eNB is connected to in the pool.

As shown in FIG. 8, at 1 in a normal operation scenario, when all MME in the pool are functioning, an initial bitmask can be set as XXXXXXXXXXXX1111. There may be 4 MMEs in S1-flex pool configured in this example.

At 2, the eNB1 can receive a SCTP: abort with fatal error or an ALNOK timer can expire for serving MME1. Then eNB1 can set bitmask to XXXXXXXXXXXX1110, indicating that MME1 application layer is not functional.

At 3, eNB1 can generate an OSS alarm indicating that MME1 is not functioning. Moreover, at 4, eNB1 can start load balancing procedures to shift new traffic towards remaining active servers, in this case MMEs, in the pool. eNB1 can also decide to remove MME1 from the pool for selection.

Optionally, in case of abort procedures with error, the eNB can get the cause code and can take specific actions as deemed necessary by the network operator. Optionally, a client such as eNB1 can intelligently send a “Reset” message to the server, in this case MME1, based on the amount of active traffic or users being served. This option may be selected based on network operator preference.

At 5, if all serving nodes, in this case MME1 to MME4, in the pool go down then the bitmask for each MME can be set to 0, yielding a bitmap of XXXXXXXXXXXX0000. In this case, eNB1 can more load balance traffic in its pool and may start redirecting traffic to other user-preferred radio access technologies.

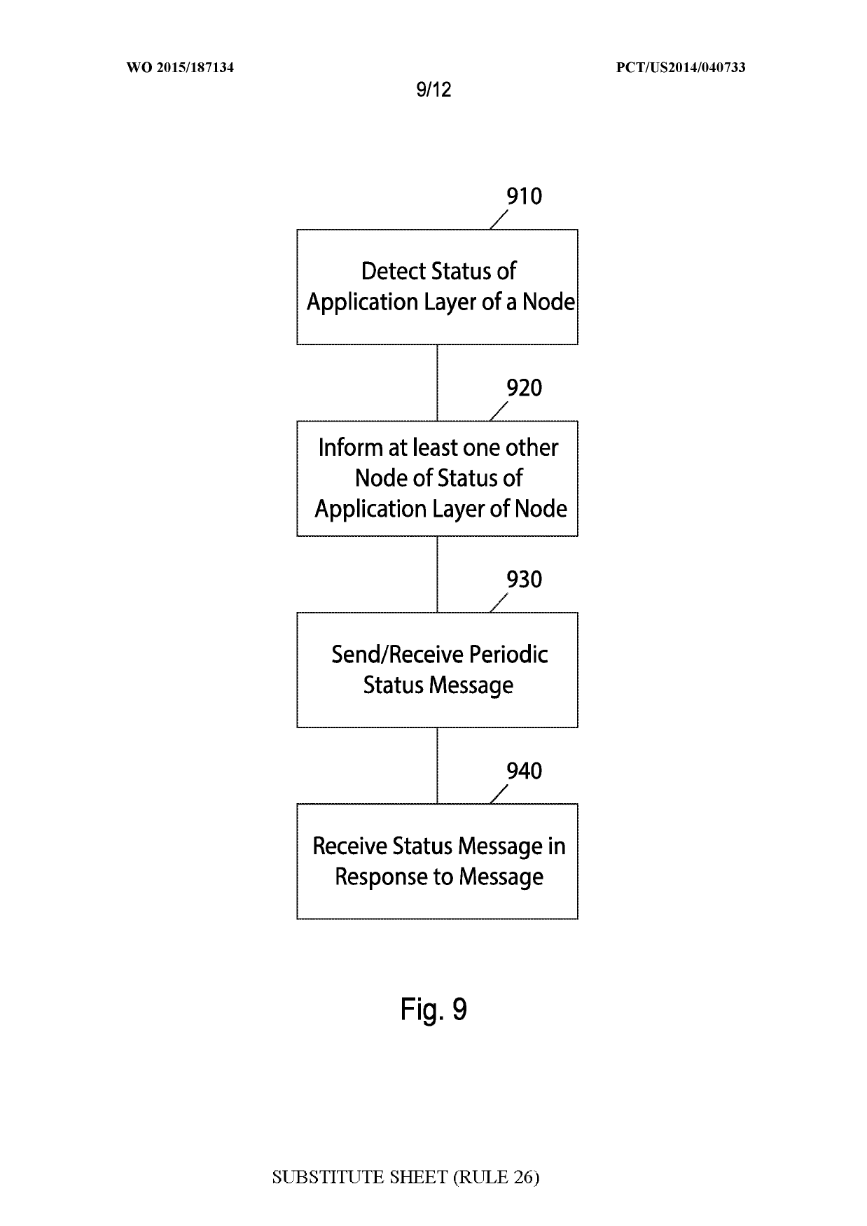

FIG. 9 illustrates a method according to certain embodiments. The method can include, at 910, detecting, by a device, status of an application layer of a node. The device can be the node, can be in communication with the node, or can be a peer node of the node. In other words, a device can determine the status of its own application layer, or a device can determine the status of an application layer of another device.

The status can be at least one of unavailability of the application layer, functional status of the application layer, or an error of the application layer. The functional status can be either “functional” or “non-functional,” or can include more granularity, such as “functioning with errors” or “functioning slowly.”

The method can also include, at 920, informing, in a message, at least one other node of the status of the application layer of the node.

The method can also include, at 930, sending or receiving a periodic status message. The informing can include sending the periodic status message or the detecting can include receiving, or failing to receive, a periodic status message.

The method can further include, at 940, receiving a status message from the other node in response to the message. A further detection can be made based on the received status message.

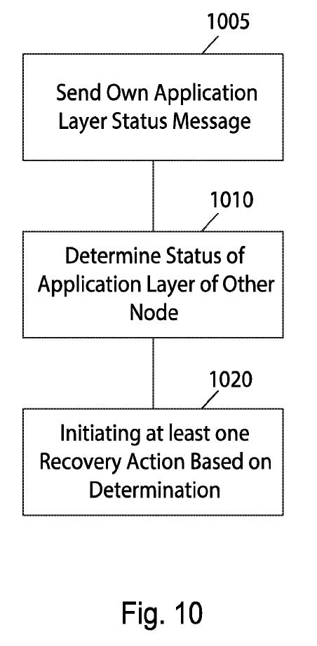

FIG. 10 illustrates another method according to certain embodiments. As shown in FIG. 10, a method can include, at 1010, determining status of an application layer of a node at an other node. The status can include at least one of unavailability of the application layer, functional status of the application layer, or an error of the application layer.

The determining can be based on at least one of receiving an indication of the status or failing to receive an indication of the status within a predetermined amount of time. The determining can be based on at least one of receiving an indication of the status or failing to receive an indication of the status within a predetermined amount of time.

The method can include, at 1005, sending an own application layer status message. The indication of the status of the application can be received in response to the application layer status message.

The method can also include, at 1020, initiating at least one recovery action based on determination of the status at the other node.

FIG. 12 illustrates an additional method according to certain embodiments. As shown in FIG. 12, a method can include, at 1210, receiving, in a streaming control transmission protocol message, a status of an application layer of a node. The method can also include, at 1220, taking at least one corrective action based on the status as received.

The corrective action can be at least one of removing the node from a pool, blocking the node, re-routing a user equipment to a new node, redirecting a user equipment to another frequency of a same or other access technology, or rejecting requests if there is no option available other than the node. Other corrective actions are also permitted.

The method can also or alternatively include fixing the node in response to the status at 1230. The fixing can include, for example, resetting or sending at least one specific command to fix an issue based on a failure code provided in the streaming control transmission protocol message.

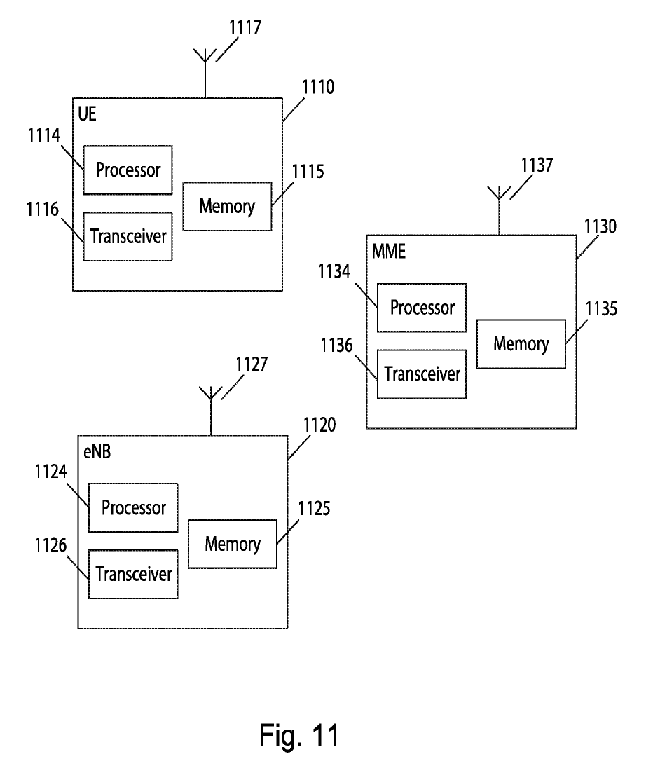

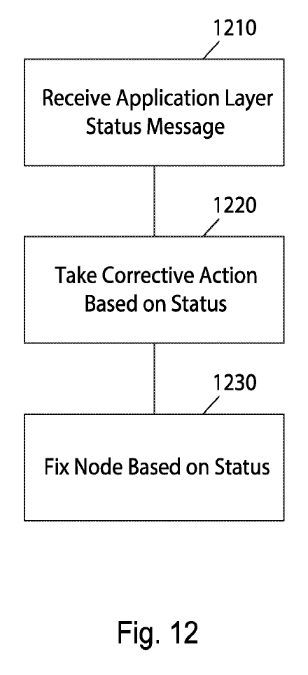

FIG. 11 illustrates a system according to certain embodiments of the invention. In one embodiment, a system may include multiple devices, such as, for example, at least one UE 1110, at least one eNB 1120 or other base station or access point, and at least one MME 1130. In certain systems, UE 1110, eNB 1120, MME 1130, and a plurality of other user equipment and MMEs may be present. Other configurations are also possible, including those with multiple base stations, such as eNBs.

Each of these devices may include at least one processor, respectively indicated as 1114, 1124, and 1134. At least one memory may be provided in each device, as indicated at 1115, 1125, and 1135, respectively. The memory may include computer program instructions or computer code contained therein. The processors 1114, 1124, and 1134 and memories 1115, 1125, and 1135, or a subset thereof, may be configured to provide means corresponding to the various blocks of FIGS. 9 and 10. Although not shown, the devices may also include positioning hardware, such as global positioning system (GPS) or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 11, transceivers 1116, 1126, and 1136 may be provided, and each device may also include at least one antenna, respectively illustrated as 1117, 1127, and 1137. The device may have many antennas, such as an array of antennas configured for multiple input multiple output (MIMO) communications, or multiple antennas for multiple radio access technologies. Other configurations of these devices, for example, may be provided. For example, eNB 1120 and MME 1130 may additionally or solely be configured for wired communication, and in such a case antennas 1127, 1137 would also illustrate any form of communication hardware, without requiring a conventional antenna.

Transceivers 1116, 1126, and 1136 may each, independently, be a transmitter, a receiver, or both a transmitter and a receiver, or a unit or device that is configured both for transmission and reception.

Processors 1114, 1124, and 1134 may be embodied by any computational or data processing device, such as a central processing unit (CPU), application specific integrated circuit (ASIC), or comparable device. The processors may be implemented as a single controller, or a plurality of controllers or processors.

Memories 1115, 1125, and 1135 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language.

The memory and the computer program instructions may be configured, with the processor for the particular device, to cause a hardware apparatus such as UE 1110, eNB 1120, and MME 1130, to perform any of the processes described above (see, for example, FIGS. 1-4 and 6-10). Therefore, in certain embodiments, a non-transitory computer-readable medium may be encoded with computer instructions that, when executed in hardware, perform a process such as one of the processes described herein. Alternatively, certain embodiments may be performed entirely in hardware.

Furthermore, although FIG. 11 illustrates a system including a UE, eNB, and MME, embodiments of the invention may be applicable to other configurations, and configurations involving additional elements.

Certain embodiments may have various benefits and/or advantages. For example, having such an ability to inform peer nodes about application status of own node and adjacent nodes, including errors, can facilitate recovery action. Indeed, such ability may prevent the error from snowballing or avalanching into a massive outage impacting a large amount of end users. Recovery action can be triggered upon failure detection in the node such that any peer node can initiate network topology realignment to ensure service continuity in the system. The same logic can be extended to various Network Element peering nodes like eNB, MME, Serving GW, PCRF, HSS, SGSN, RNC, NodeB, CSCF, MSC/VLR and the like.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

3G Third Generation

3GPP Third Generation Partnership Project for UMTS

3GPP2 Third Generation Partnership Project for CDMA 2000

BBERF Bearer Binding Event Reporting Function

CDMA Code Division Multiple Access

CDR Charge Data Record

CSCF Call Session Control Function

DL Downlink

DNS Domain Name Server

ECGI Enhanced Cell Global Identity

EGPRS Enhanced General Packet Radio Services

eNB Evolved Node B

EPC Evolved Packet Core

EUTRAN Evolved UTRAN

GGSN Gateway GPRS Support Node

GSM Global System for Mobile Communications

GUGI Global Unique Group ID

GUTI Globally Unique Temporary ID

GUMMEI Global Unique Mobility Management Entity

HSDPA High Speed Downlink Packet Access

HSGW High Speed Packet Data Serving Gateway

HSS Home Subscriber Server

HRL Handover Restriction List

ID Identifier

IMS IP Multimedia Sub System

IMSI International Mobile Subscriber Identity

LTE Long Term Evolution

MME Mobility Management Entity

MOCN Multi-Operator Core Network

MOWN Multi Operator Wholesale Network

PLMN Public Land Mobile Network

PCRF Policy Charging and Rules Function

PCI Physical Cell ID

PDN Packet Data Network

PGW PDN Gateway

RDP Retail Distribution Partner

SGW Serving Gateway

SCTP Streaming Control Transmission Protocol

S1AP S1-Application Protocol

TAI Tracking Area Identity

TAC Tracking Area Code

UDR User Data Request

UDA User Data Acknowledge

UE User Equipment

UL Uplink

UMTS Universal Mobile Telecommunication System

UTRAN Universal Terrestrial Radio Access Network

WCDMA Wideband Code Division Multiple Access

1. A method, comprising:
detecting, by a device, status of an application layer of a node; and
informing, in a streaming control transmission protocol message, at least one other node of the status of the application layer of the node.

2. The method of claim 1, wherein a vendor-specific information is included in the streaming control transmission protocol message.

3. The method of claim 2, wherein the vendor-specific information element is used exclusively to relay own node and all peer node application layer and functional status over the streaming control transmission protocol message to an adjacent node.

4. The method of claim 3, wherein the vendor-specific information element is used over at least one protocol layer of S1AP, S6A, Diameter, Radius, or a Third Generation Partnership Project network-element-related protocol stack.

5. The method of claim 4, wherein the status of the application layer is configured to be used to take at least one corrective action by a receiving node to ensure system functionality and service assurance.

6. The method of claim 5, wherein the at least one corrective action includes at least one of changing a priority of a connection toward a faulty node, blacklisting a faulty node, prioritizing a working node, or whitelisting a working node.

7. The method of claim 4, wherein the status of the application layer is configured to be used to build an end-to-end topology of a system from every individual node perspective, such than an operator can interpret topology of a functional network architecture and relevant active nodes from any give node based the status received and any corrective actions taken by the node.

8. The method of claim 1, wherein the status comprises at least one of unavailability of the application layer, functional status of the application layer, or an error of the application layer.

9. The method of claim 1, wherein the device is the node, is in communication with the node, or is a peer node of the node.

10. The method of claim 1, wherein the informing comprises sending a periodic status message or the detecting comprises receiving a periodic application layer status information over streaming control transmission protocol message.

11. The method of claim 1, further comprising:
receiving a status message from the other node in response to the message.

12.-15. (canceled)

16. A method, comprising:
receiving, in a streaming control transmission protocol message, a status of an application layer of a node; and
taking at least one corrective action based on the status as received.

17. The method of claim 16, wherein the corrective action comprises at least one of removing the node from a pool, blocking the node, re-routing a user equipment to a new node, redirecting a user equipment to another frequency of a same or other access technology, or rejecting requests if there is no option available other than the node.

18. The method of claim 16 or claim 17, further comprising:
fixing the node in response to the status.

19. The method of claim 18, wherein the fixing comprises resetting or sending at least one specific command to fix an issue based on a failure code provided in the streaming control transmission protocol message.

20. An apparatus, comprising:
at least one processor; and
at least one memory including computer program code,
wherein the at least one memory and the computer program code are configured to, with the at least one processor, cause the apparatus at least to
detect, by a device, status of an application layer of a node; and
inform, in a streaming control transmission protocol message, at least one other node of the status of the application layer of the node.

21.-30. (canceled)

31. An apparatus, comprising:
at least one processor; and
at least one memory including computer program code,
wherein the at least one memory and the computer program code are configured to, with the at least one processor, cause the apparatus at least to
determine status of an application layer of a node at an other node; and
initiate at least one recovery action based on determination of the status at the other node.

32.-34. (canceled)

35. An apparatus, comprising:
at least one processor; and
at least one memory including computer program code,
wherein the at least one memory and the computer program code are configured to, with the at least one processor, cause the apparatus at least to
receive, in a streaming control transmission protocol message, a status of an application layer of a node; and
take at least one corrective action based on the status as received.

36.-57. (canceled)

58. A non-transitory computer readable medium encoded with instructions that, when executed in hardware, perform a process, the process comprising the method according to claim 1.

59. (canceled)
